(19) United States
(12) Patent Application Publication
(10) Pub. No.: US 2026/0100742 A1
(43) Pub. Date: Apr. 9, 2026

(54) JOINT TRANSMISSION IN DISTRIBUTED MIMO WITH CHANNEL STATE INFORMATION SHARING

(71) Applicant: Samsung Electronics Co., Ltd., Suwon-si (KR)

(72) Inventors: Rui Huang, Vancouver (CA); R A Nadisanka Perera Rupasinghe, McKinney, TX (US); Yang Li, Dallas, TX (US); Jianzhong Zhang, Dallas, TX (US)

(21) Appl. No.: 19/348,498

(22) Filed: Oct. 2, 2025

Related U.S. Application Data
(60) Provisional application No. 63/704,808, filed on Oct. 8, 2024.

(51) Int. Cl. H04B 7/06; H04L 1/00; H04L 25/02; H04W 52/36

(52) U.S. Cl. CPC H04B 7/0626; H04L 1/0003; H04L 25/0202; H04W 52/367

(57) ABSTRACT

Methods and apparatuses for a joint transmission in a distributed MIMO with CSI sharing in wireless communication systems. The method of a network entity comprises: receiving, from multiple transmit-receive-points (mTRPs), channel estimate information associated with user equipments (UEs) communicated to the mTRPs; identifying, based on the channel estimate information, a rank, an antenna order, and a modulation and coding scheme (MCS) for channels transmitted to the mTRPS; receiving, from active mTRPs among the mTRPs, joint channel state information (CSI) of a UE, wherein the active mTRPS simultaneously communicate with the UE; and performing a precoding operation to identify, based on the joint CSI, a precoder for the UE.

### CROSS-REFERENCE TO RELATED APPLICATIONS AND CLAIM OF PRIORITY

The present application claims priority to U.S. Provisional Patent Application No. 63/704,808, filed on Oct. 8, 2024. The contents of the above-identified patent documents are incorporated herein by reference.

### TECHNICAL FIELD

The present disclosure relates generally to wireless communication systems and, more specifically, the present disclosure relates to a joint transmission in a distributed multi-input multi-output system (MIMO) with channel state information (CSI) sharing in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a joint transmission in a distributed MIMO with CSI sharing in wireless communication systems.

In one embodiment, a network entity in a wireless communication network is provided. The network entity comprises a transceiver configured to receive, from multiple transmit-receive-points (mTRPs), channel estimate information associated with user equipments (UEs) communicated to the mTRPs. The network entity further includes a processor operably coupled to the transceiver, the processor configured to identify, based on the channel estimate information, a rank, an antenna order, and a modulation and coding scheme (MCS) for channels transmitted to the mTRPS, wherein the transceiver is further configured to receive, from active mTRPs among the mTRPs, joint CSI of a UE, wherein the active mTRPS simultaneously communicate with the UE, and wherein the processor is further configured to perform a precoding operation to identify, based on the joint CSI, a precoder for the UE.

In another embodiment, a method of a network entity in a wireless communication network is provided. The method comprises: receiving, from mTRPs, channel estimate information associated with UEs communicated to the mTRPs; identifying, based on the channel estimate information, a rank, an antenna order, and an MCS for channels transmitted to the mTRPS; receiving, from active mTRPs among the mTRPs, joint CSI of a UE, wherein the active mTRPS simultaneously communicate with the UE; and performing a precoding operation to identify, based on the joint CSI, a precoder for the UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of distributed MIMO according to various embodiments of the present disclosure;

FIG. 8 illustrates another example of distributed MIMO according to various embodiments of the present disclosure;

FIG. 9 illustrates a flowchart of a method for a joint transmission according to various embodiments of the present disclosure;

FIG. 10 illustrates another example of 2 TRPs connected to the same DU according to various embodiments of the present disclosure; and

FIG. 11 illustrates a flowchart of a method for a joint transmission in a distributed MIMO with CSI sharing according to various embodiments of the present disclosure.

### DETAILED DESCRIPTION

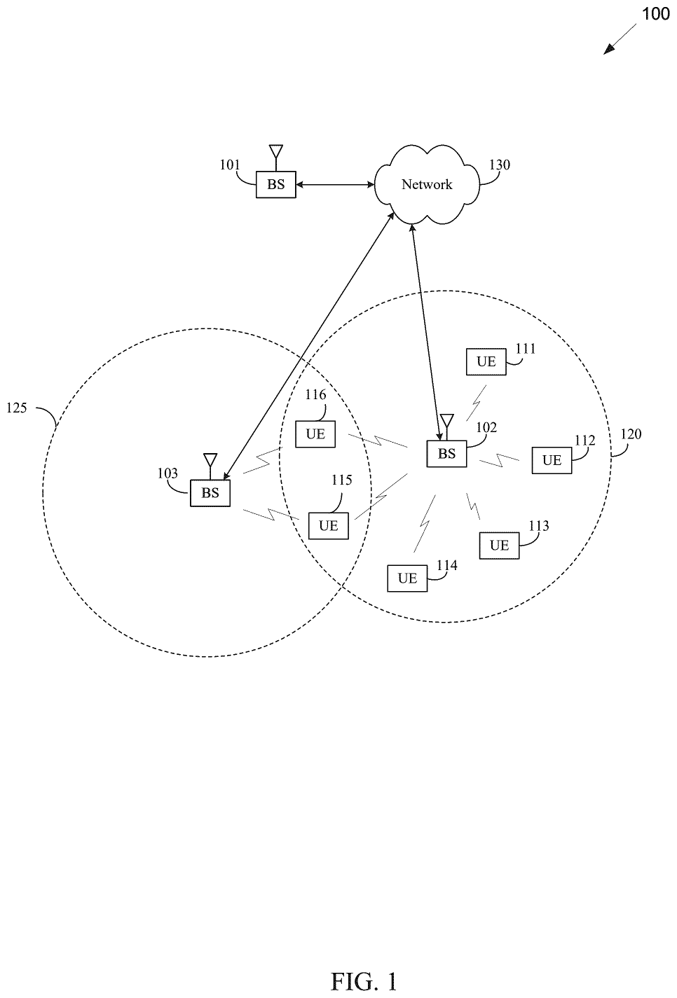

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.211 v16.4.0, “E-UTRA, Physical channels and modulation”; 3GPP TS 36.212 v16.4.0, “E-UTRA, Multiplexing and Channel coding”; 3GPP TS 36.213 v16.4.0, “E-UTRA, Physical Layer Procedures”; 3GPP TS 36.321 v16.3.0, “E-UTRA, Medium Access Control (MAC) protocol specification”; 3GPP TS 36.331 v16.3.0, “E-UTRA, Radio Resource Control (RRC) Protocol Specification”; 3GPP TS 38.211 v16.4.0, “NR, Physical channels and modulation”; 3GPP TS 38.212 v16.4.0, “NR, Multiplexing and Channel coding”; 3GPP TS 38.213 v16.4.0, “NR, Physical Layer Procedures for Control”; 3GPP TS 38.214 v16.4.0, “NR, Physical Layer Procedures for Data”; 3GPP TS 38.215 v16.4.0, “NR, Physical Layer Measurements”; 3GPP TS 38.321 v16.3.0, “NR, Medium Access Control (MAC) protocol specification”; and 3GPP TS 38.331 v16.3.1, “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a joint transmission in a distributed MIMO with CSI sharing, at a gNB 101-103, in wireless communication systems. In certain embodiments, and one or more of the gNBs 101-103 includes circuitry, programing, or a combination thereof, to support a joint transmission in a distributed MIMO with CSI sharing in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

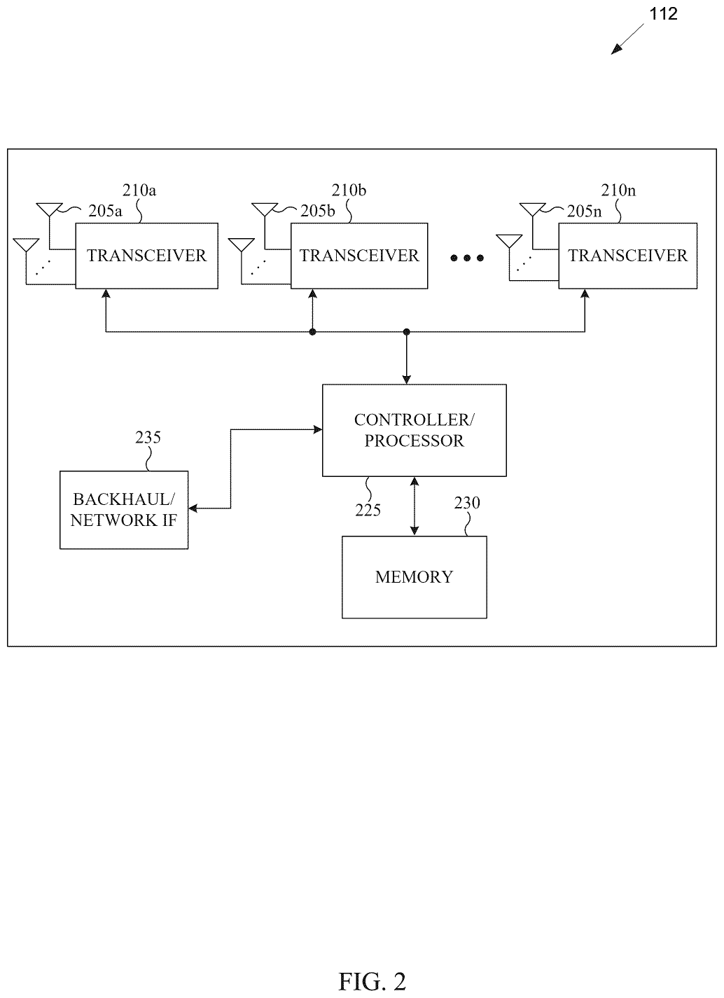

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a joint transmission in a distributed MIMO with CSI sharing in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

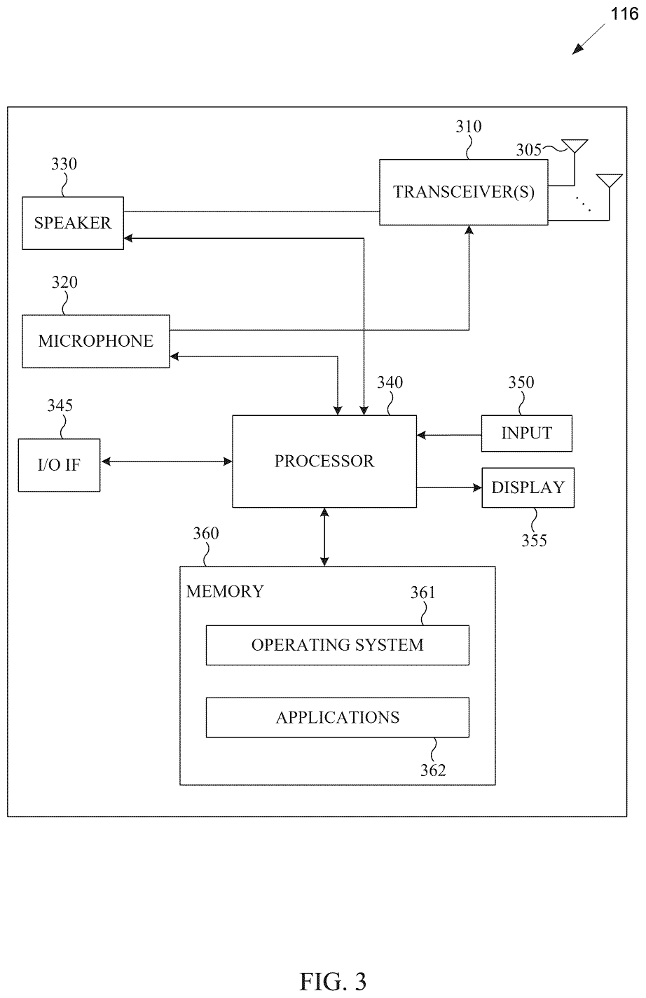

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a joint transmission in a distributed MIMO with CSI sharing, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

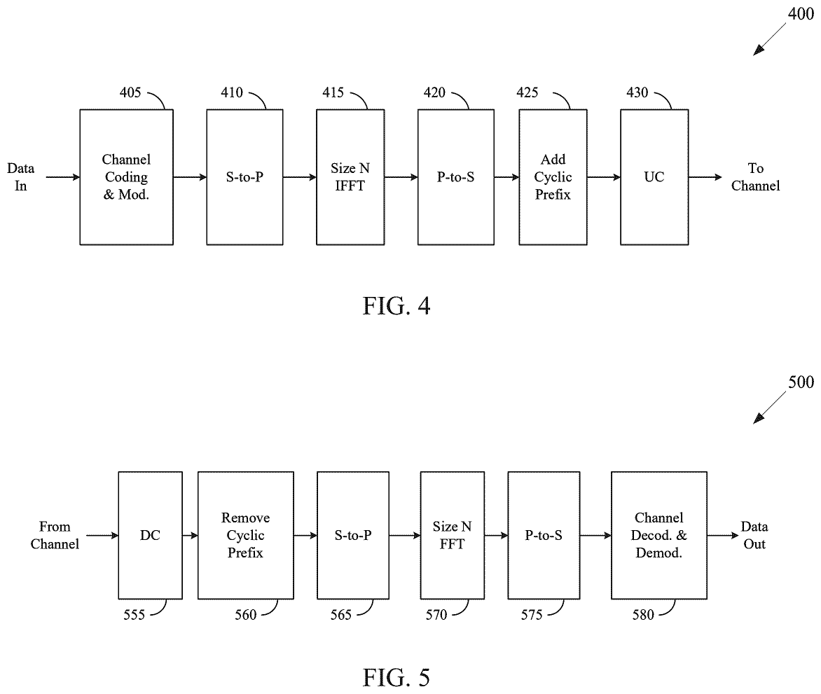

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

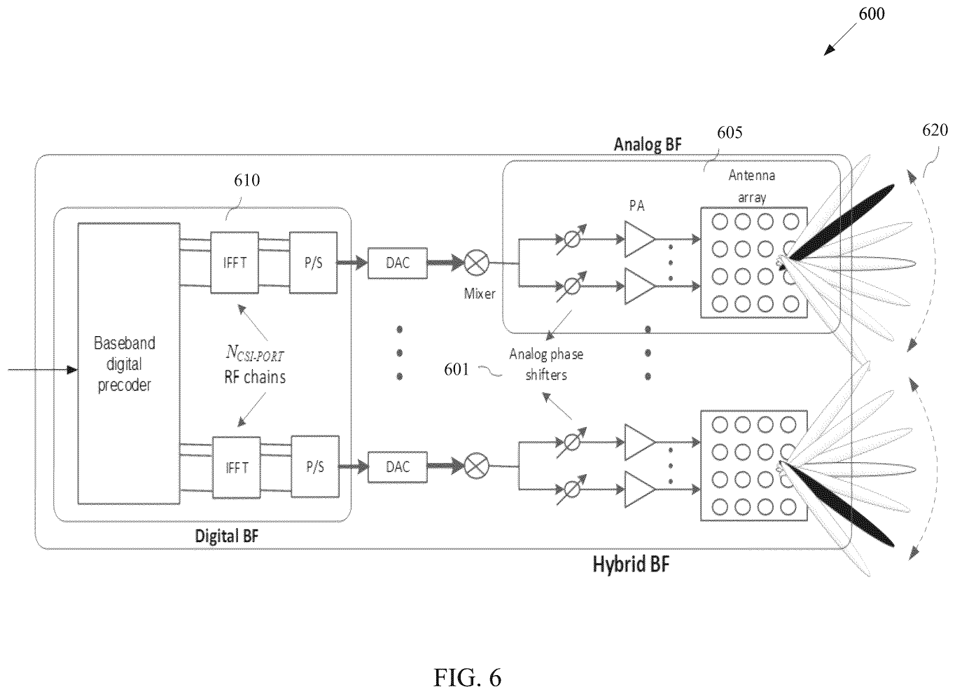

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss at 100 m distance), larger number of and sharper analog beams (hence larger number of radiators in the array) may compensate for the additional path loss.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

The present disclosure provides a system (called distributed MIMO or multi-transmission-reception point (mTRP) or coherent joint transmission (CJT)) and provides methods to perform signal processing for the RF receive/transmit antenna network of multiple RRHs/panels in the system to support simultaneous transmission from multiple TRPs to multiple user equipments (UEs), where the provided methods can be realized based on link adaptation, precoding, multi-antenna processing, codebook, and feedback design for the purposes of interference cancellation and throughput enhancement.

In one embodiment, electronic devices and methods on precoding and beamforming methods for (distributed) MIMO operations are provided. More particularly, electronic devices and methods for multiuser precoding, interference management, and throughput enhancement in (distributed) MIMO of wireless networks are provided.

Link adaptation and precoder design are important issues for distributed MIMO for enhancing the received signal power and mitigate the interference, especially when multiple UEs scheduled to share the same time, frequency, and power resources. Specifically, for link adaptation, a proper rank may be determined based on the DL channels between all the participating TRPs and the scheduled UEs.

In order to design the precoding for each scheduled users, explicit or implicit signalings are used to obtain the information about the UL/DL CSI between the antenna ports of transmitters and receivers. With such information about the UL/DL channels, the precoder for each UE can be properly derived to potentially maximize the signal-to-noise-plus-interference ratio (SINR) of the received signal, thereby achieving a higher throughput.

Apart from rank and precoder determinations, the transmit power of each participating TRP may be properly controlled, and optimized based on various factors, including DL CSI, precoders, and rank decisions of all scheduled UEs at all participating TRPs.

In light of this, the link adaptation, precoder design, and power control in distributed MIMO may be designed carefully to accommodate the channel conditions between all the scheduled UEs and all participating TRPs. The aforementioned decisions were made solely based on the information of only one or a subset of the participating TRPs, while the information available at the remaining TRPs has not been explored. The resulting link adaptation, precoder design, and power control were often sub-optimal due to the lack of consideration of CSI between remaining TRP and scheduled UEs. Without properly designing methods to perform link adaptation, precoding, and power control based on the joint information available at all participating TRPs, it is difficult to achieve the full potential of distributed MIMO systems.

In the present disclosure, the distributed MIMO systems where all participating TRPs are capable of sharing channel statement information with other TRPs are provided, and several DL transmission methods (for link adaptation, precoding, and power control) are provided to improve the system throughput.

In one embodiment, DL transmission methods (including link adaptation, precoding, and power control) are provided for the distributed MIMO systems where all participating TRPs are capable of sharing information with each other. The provided methods exploit the global information that are collected from all the TRPs, to improve the link adaptation, precoding, and power control in distributed MIMO systems. In particular, the present disclosure provides multiple methods to determine the proper rank and antenna ordering, based on the channels estimated by multiple TRPs of the scheduled UEs.

Moreover, in the present disclosure, a precoding method is provided to derive the precoders for the scheduled UEs based on the joint CSI collected from multiple participating TRPs. In addition, in order to meet the hardware requirements regarding transmit power control, the present disclosure provides several methods to adjust the transmit power at each TRP as well as each antenna, such that the maximum transmit power constraint and per-antenna transmit power constraint (PAPC) can be satisfied. The present disclosure also provides extensive performance evaluation results to demonstrate the effectiveness of the methods provided on improving the throughput of the distributed MIMO systems.

In the present disclosure following embodiments are provided: (i) determining a rank, an antenna order, and an MCS based on one or more channels estimated by multiple transmit-receive-points (TRPs) of one or more scheduled user equipment devices (UEs); (ii) determining, via a precoding process, one or more precoders for the one or more scheduled UEs based on joint CSI collected from the multiple participating TRPs; (and iii) adjusting a transmit power at each of the multiple TRPs and at each antenna for one or more layer to satisfy a maximum transmit power constraint and a PAPC.

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

At lower frequency bands such as FR1 or particularly sub-1 GHz band, on the other hand, the number of antenna elements cannot be increased in a given form factor due to large wavelength if a critical distance (≥λ/2) between two adjacent antenna elements is maintained in deployment scenarios. As an example, for the wavelength size (λ) of the center frequency 600 MHz (which is 50 cm), 4 m may be required for uniform-linear-array (ULA) antenna panel of 16 antenna elements with the half-wavelength distance between two adjacent antenna elements. Considering a plurality of antenna elements is mapped to one digital port in practical cases, the desired or required size for antenna panels at gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limit the spectral efficiency of such systems.

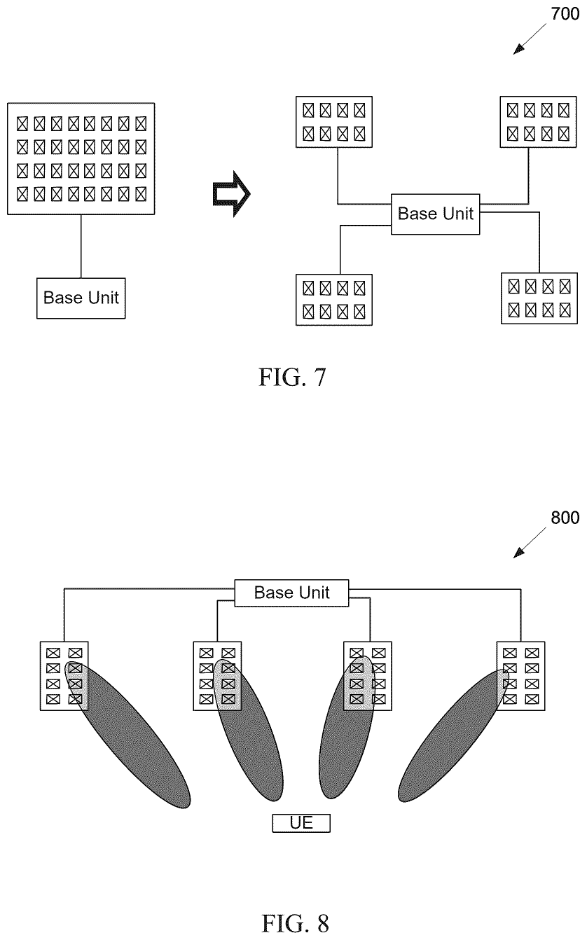

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 7.

FIG. 7 illustrates an example of distributed MIMO 700 according to various embodiments of the present disclosure. An embodiment of the distributed MIMO 700 shown in FIG. 7 is for illustration only.

The multiple antenna panels at multiple locations can still be connected to a single base unit, and thus the signal transmitted/received via multiple distributed panels can be processed in a centralized manner through the single base unit, as illustrated in FIG. 8.

FIG. 8 illustrates another example of distributed MIMO 800 according to various embodiments of the present disclosure. An embodiment of the distributed MIMO 800 shown in FIG. 8 is for illustration only.

In another embodiment, it is possible that multiple distributed antenna panels are connected to more than one base units, which communicates with each other and jointly supporting single antenna system.

In TDD, a common approach to acquire DL channel state information is to exploit UL channel estimation through receiving UL RSs (e.g., SRS) sent from a UE. By using the channel reciprocity in TDD systems, the UL channel estimation itself can be used to infer DL channels. This favorable feature enables an NW to reduce the training overhead significantly. However, due to the RF impairment at transmitter and receiver, directly using the UL channels for DL channels is not accurate and it may perform a calibration process (periodically) among receive and transmit antenna ports of the RF network at the NW.

In general, a NW has an on-board calibration mechanism in its own RF network to calibrate its antenna panels having a plurality of receiver/transmitter antenna ports, to enable DL/UL channel reciprocity in channel acquisition. The on-board calibration mechanism can be performed via small-power RS transmission and reception from/to the RF antenna network of the NW and thus it can be done by NW's implementation in a confined manner (i.e., that does not interfere with other entities). However, it becomes difficult to perform the on-board calibration in distributed MIMO systems due to the distribution of the panels/RRHs over a wide region, and thus it may achieve over-the-air (OTA) signaling mechanisms to calibrate receive/transmit antenna ports among multiple RRHs/panels far away in distributed MIMO.

The present disclosure provides precoding methods for distributed MIMO systems where different base stations and UEs are using different formats of explicit and implicit signaling to obtain CSI information. Explicit signaling may include reference signals that directly reflect the values of the entries in the channel matrix/vector, for example, an SRS. Implicit signaling may indicate the properties of the CSI and the preferred precoders, instead of directly reflecting the values of the entries in the channel matrix/vector. Examples of implicit signaling may include a precoding matrix indicator (PMI). In the following, an SRS is used as an example for explicit signaling, and PMI reports as an example for implicit signaling. However, the provided methods can also be applied to other explicit and implicit signaling, such as other reference signals including CSI-RS, SRS, and demodulation reference signals (DMRS).

Although low-band TDD systems are exemplified for motivation purposes, the present disclosure can be applied to any frequency band in FR1 and/or FDD systems.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can comprise one or multiple slots) or one slot.

In one embodiment, the case comprising one scheduled UE being served by two TRPs is provided, namely TRP 1 and TRP2, as the example while the provided methods can be applied to the scenarios with more than one UEs for each type, and one or more TRP serving one or more UE.

For the scheduled UE, since SRS signals are available at both TRP 1 and TRP 2, the channels estimated, based on SRS between this UE and TRP 1 and TRP 2, are denoted as H₁ and H₂, respectively. The present disclosure provides a design method for (1) the rank and antenna ordering for the transmission of scheduled UE, (2) the precoders W₁ and W₂ where W₁ and W₂ are the precoders for this UE at TRP 1 and TRP 2, respectively, and (3) the adjustments applied to precoders W₁ and W₂ in order to satisfy the per-TRP power constraint (PTPC) and PAPC.

In one embodiment of step 1, joint link adaptation (LA) for the scheduled UE is provided. In this step, the rank and antenna ordering are determined for the scheduled UE based on the joint CSI of TRP 1 and TRP 2 for the scheduled UE. Such joint CSI H can be determined by the concatenation of the SRS channel estimated at TRP 1 and TRP 2. That is, H=[H₁, H₂]E C^{N}^{_{R}}^{×N}^{_{T}}, where N_{R} and N_{T} are the number of antenna ports at the UE and TRPs, respectively.

In one embodiment, joint LA based on estimated DL SINR with exhaustive search is provided.

In one embodiment, the optimal rank RI and antenna order a are determined by performing an exhaustive search over all possible combinations of (RI, a) that achieves the maximum sum modulation order product code rate (MPR).

Given a particular rank RI and antenna ordering a=[aᵢ], i=1, . . . , RI, the actual DL SINR is estimated as follows. First, a subset of the joint channel H is selected as Ĥ∈C^{RI*N}^{_{T}} based on rank and antenna ordering. In order to estimate the DL SINR, a presumable precoder W is derived as Ŵ=Ĥ^{H}(ĤĤ^{H})⁻¹. Then, the presumable precoded signals can be determined by G=H₁Ŵ+H₂Ŵ∈C^{N}^{_{R}}^{*RI}. As the next step, TRP now derived the MMSE receiver that is expected to be applied at the UE side as

$$V = \frac{{G}^{H}}{Intf + G {G}^{H}} ∈ {C}^{RI * {N}_{R}} ,$$

where intf is the estimated interference level experienced at the UE side. Note that this level of interference can be approximated by the feedbacks (e.g., ACK/NACK, OCI, etc.) reported by the UE. Using the derived MMSE receiver, the expected received signal at the UE can be estimated as Y=VHŴ=[yᵢⱼ], where yᵢⱼ denote the element on the i-th row and j-th column in matrix Y.

Now, the expected DL SINR at each layer i can be calculated as

$$SINR ( {a}_{i} ) = \frac{{\vert {y}_{i i} \vert}^{2}}{( OCI + {σ}^{2} ) * {‖ V ( i , : ) ‖}_{2}^{2}} ,$$

where σ² is noise power, and OCI denotes the estimated interference level based on the feedbacks from the UE. With the calculated DL SINR, first the OLRC and RI offset are added as reported by the UE as

$$SINR ( {a}_{i} ) = SINR ( {a}_{i} ) * \frac{{10}^{0.1 * OLRC}}{RI} .$$

Then, the achievable MPR based on the calculated SINR is determined by:

$$MPR ( {a}_{i} ) = max ( 0 , min ( {log}_{2} ( 1 + \frac{SINR ( {a}_{i} )}{{CQI}_{backoff}} ) , maxMRP ) ) \qquad ( 1 )$$

Where CQI_{backoff} and maxMRP are two predefined parameters based on systems' specifications or requirements.

Using equation (1) and the aforementioned steps, the MPR is calculated for all possible combinations of (RI, a), and find the one that achieves the maximum MPR. That is, the optimal RI* and antenna ordering a* is determined by:

$$( {RI}^{*} , {a}^{*} ) = {arg max}_{( RI , a )} {Σ}_{{a}_{i} ∈ ( RI , a )} MPR ( {a}_{i} ) \qquad ( 2 )$$

In one embodiment, joint LA with greedy selection is provided. In such embodiment, the best antenna ordering a* is identified first while fixing the value of rank RI to the maximum allowable rank. That is, with RI=RI^{max} where RI^{max} denotes the maximum rank, first the antenna ordering that achieves the maximum objectives g(⋅) is identified:

$${a}^{*} = {arg max}_{a} g ( a ) , subject to R I = {RI}^{max} \qquad ( 3 )$$

In one embodiment, the objective g(⋅) can be the same as the achievable MPR as derived in equation (1). In this case, the aforementioned steps can be applied to calculate the objective g(a).

In another embodiment, the objective g(⋅) can be estimated as the beamforming gain that can be achieved using the given antenna ordering a.

After finding the best antenna ordering, the preferred rank is finding the best RI* that achieves the maximum objectives g(⋅), with antenna ordering is fixed as a*. That is,

$${RI}^{*} = {arg max}_{RI} g ( RI ) , subject to a = {a}^{*} \qquad ( 4 )$$

In one embodiment of Step 2, joint precoder determination is provided. With the rank and antenna ordering determined as (RI*, a*), the channel matrix for computing the precoder can be obtained by selecting the subchannels in the joint channel H as Ĥ∈C^{RI*N}^{_{T}} based on (RI*, a*).

Then, the joint precoder W can be derived using various methods. In one example, zero-forcing precoding can be applied to derive the joint precoder W as W=[W₁, W₂]=Ĥ^{†}, where Ĥ^{†} denotes the Moore-Penrose inverse of matrix Ĥ. Other precoding techniques can be applied to derive the joint precoder W. The methods provided in the present disclosure can be applied to an arbitrary precoding methods.

In one embodiment of step 3, per-TRP transmit power control is provided. Given the joint precoder W, it is possible that some of the participating TRP may violate the maximum transmit power constraint. The present disclosure provides to adjust the joint precoder W with the following two options to make sure all TRP can satisfy the maximum transmit power constraint.

In one embodiment, joint per-TRP per-layer power control is provided. In such embodiment, the transmit powers are jointly controlled across all participating TRP over each layer. Specifically, with W=[W₁, W₂], the first and second parts in the joint precoder correspond to the precoders for TRP 1 W₁ and the precoder for TRP 2 W₂, respectively. In addition, there may be W₁=[w_{1,1}, . . . , w_{1,RI*}] and W₂=[w_{2,1}, . . . , w_{2,RI*}], where w_{1,1} is the precoding vector at the i-th TRP for the j-th layer.

Then, for each scheduled rank j=1, . . . , RI*, the precoders w_{1,j} and w_{2,j} as

$${\tilde{w}}_{1 , j} = \frac{{w}_{1 , j}}{{c}_{j} \sqrt{{RI}^{*}}} , {\tilde{w}}_{2 , j} = \frac{{w}_{2 ,}}{{c}_{j} \sqrt{{RI}^{*}}} , where {c}_{j} = max ( ‖ {w}_{1 , j} ‖ , ‖ {w}_{2 , j} ‖ ) \qquad ( 5 )$$

In one embodiment, joint per-TRP power control is provided. In such embodiment, the transmit power are jointly controlled across all participating TRP. Specifically, the precoders W₁ and W₂ are updated as

$${\tilde{W}}_{1} = \frac{{W}_{I}}{c \cdot \sqrt{{RI}^{*}}} , {\tilde{W}}_{2} = \frac{{W}_{2}}{c \cdot \sqrt{{RI}^{*}}} , where c = max ( {‖ {W}_{1} ‖}_{2} , {‖ {W}_{2} ‖}_{2} ) \qquad ( 6 )$$

In one embodiment, an individual per-TRP Per-Layer power control operation is provided. In such embodiment, the transmit power are individually controlled at each TRP. Specifically, for each scheduled rank j=1, . . . , RI* at TRP i, the precoders w_{i,j} is updated as

$${\tilde{w}}_{1 , j} = \frac{{w}_{1 , j}}{‖ {w}_{1 , j} ‖ \sqrt{{RI}^{*}}} \qquad ( 7 )$$

In this case, the precoders after per-TRP power control are denoted as \tilde{W}₁ and \tilde{W}₂.

In one embodiment of step 4, PAPC is provided. After the per-TRP power control, some of the antennas at the TRP may still be allocated with a transmit power that exceed the maximum allowable amount. In order to satisfy the PAPC, the present disclosure provides the following options to further update precoders \tilde{W}₁ and \tilde{W}₂.

For the precoder w_{i,j}, it can be further denoted as w_{i,j}=[w_{i,j,1} . . . w_{i,j,N}_{_{T}}], where w_{i,j,k} is the precoder for the i-th TRP, at the j-th layer, at the k-th antenna port. Then, the accumulated transmit power at the k-th antenna port of the i-th TRP can be calculated as

$${p}_{i , k} = {\sum }_{j = 1 , … , {RI}^{*}} {‖ {w}_{i , j , k} ‖}^{2} \qquad ( 8 )$$

When RB-level precoder is used, let w_{i,j,k,r} denotes the precoder for the i-th TRP, at the j-th layer, at the k-th antenna port, at the r-th RB. Then, the accumulated transmit power at the k-th antenna port of the i-th TRP can be calculated as

$${p}_{i , k} = {\sum }_{j = 1 , … , {RI}^{*}} {\sum }_{r = 1 , … , {N}_{R B}} {‖ {w}_{i , j , k , r} ‖}^{2} \qquad ( 9 )$$

Where N_{RB} is the number of RBs.

In one embodiment, joint PAPC across all antennas of all TRPs is provided. In such embodiment, the precoders \tilde{W}₁ and \tilde{W}₂ are updated based on the maximum transmit power across all antennas over all participating TRPs. Specifically, \tilde{W}₁ and \tilde{W}₂ are updated as

$${\hat{W}}_{1} = \frac{{\tilde{W}}_{1}}{p \cdot \sqrt{{N}_{T} \cdot {N}_{R B}}} , {\hat{W}}_{2} = \frac{{\tilde{W}}_{2}}{p \cdot \sqrt{{N}_{T} \cdot {N}_{R B}}} , where p = {max}_{k} {\sum }_{i = 1 , 2} {p}_{i , k} \qquad ( 10 )$$

In one embodiment, an individual PAPC across all antennas of each TRP is provided. In such embodiment, the precoders \tilde{W}₁ and \tilde{W}₂ are updated based on the maximum transmit power across all antennas of at each TRP. Specifically, \tilde{W}ᵢ is updated as

$${\hat{W}}_{i} = \frac{{\tilde{W}}_{i}}{{p}_{i} \cdot \sqrt{{N}_{T} \cdot {N}_{R B}}} , where {p}_{i} = {max}_{k} {p}_{i , k} \qquad ( 11 )$$

Note that, when wide-band precoding is considered, N_{RB} can be set to 1 in equations (10) and (11).

In one embodiment of step 5, proceed with Ŵ₁ and Ŵ₂ for DL transmission at TRP 1 and TRP 2, respectively, is provided.

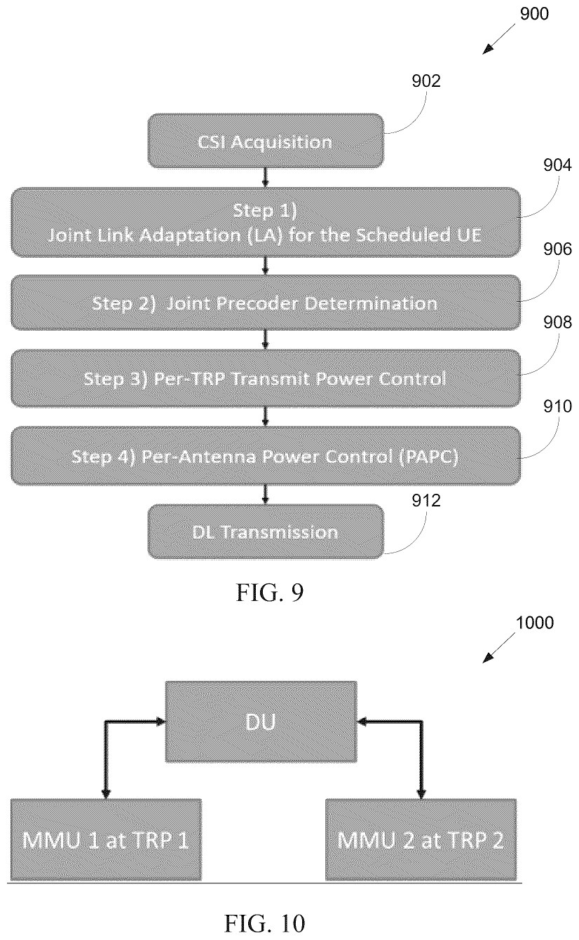

FIG. 9 illustrates a flowchart of a method 900 for a joint transmission according to various embodiments of the present disclosure. The method 900 may be performed by a network entity (e.g., base station, 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in step 902, a base station receives the CSI from the UE. In step 904, in step 1, the BS performs the LA for the scheduled UE. Subsequently, in step 906, in step 2, the BS determines the joint precoder. Subsequently, in step 908, the BS performs per-TRP transmit power control operation. Next, in step 910, the BS performs a PAPC operation. And finally, in step 912, the BS transmit the DL to the UE.

FIG. 10 illustrates another example of 2 TRPs connected to the same DU 1000 according to various embodiments of the present disclosure. An embodiment of the TRPs connected to the same DU 1000 shown in FIG. 10 is for illustration only.

The steps and methods provided in the present disclosure can be implemented in distributed MIMO systems in various ways. In one embodiment, aforementioned step 1 can be performed at the DU (as illustrated in FIG. 10) based on the estimated CSI sent from MMU 1 and MMU 2. The steps as disclosed in the present disclosure can be performed at MMU 1 and MMU 2, with necessary or desired information being shared via and/or from DU to each TRP.

In another embodiment, the steps as disclosed in the present disclosure can be performed at the DU based on the estimated CSI sent from MMU 1 and MMU 2. After necessary or desired information being shared via and/or from DU to each TRP, including the derived precoders, Step 5 can be performed at each MMU.

In one embodiment, it is possible to have more than 2 TRPs connected to the same DU and aforementioned methods and procedures are still applicable to derive joint precoders across all those TRPs.

In the present disclosure, a simulation platform is provided such as 3GPP NR system-level simulator (SLS). This SLS accurately models the practical distributed MIMO systems, and therefore the results obtained from the SLS can effectively reflect the performance of the provided methods when deployed in practice. All the reported results are averaged over 900 UE drops (i.e., different channel realizations and UE locations) to provide comprehensive evaluations. The following two baselines are compared with each other: (i) baseline 1: only TRP 1 serves the UE. The precoder for the UE is determined by the classic zero-forcing precoder; (ii) baseline 2: both TRP 1 and TRP 2 serve the UE. In this baseline, link adaptation, precoder, and power control is performed at each individual TRP, without considering the joint CSI of two TRPs; and (iii) baseline 3: only TRP 1 serves the UE. The precoder for the UE is determined by the classic zero-forcing precoder. However, in this baseline, TRP 1 has twice the number of transmit antenna and transmit power than all other baselines and the provided methods.

The results in TABLE 1 and TABLE 2 show that the methods provided can effectively improve the system throughput, which benefits from effectively exploiting the joint CSI available in the distributed MIMO systems, to improve the decision on link adaptation, precoding, as well as power controls.

TABLE 1
Average throughput achieved by the UEs

| Methods | Average Throughput Achieved by UEs |
|---|---|
| This DOI | 261.7 Mbps (113.9%) |
| Baseline 1 | 229.7 Mbps (100%) |
| Baseline 2 | 253.0 Mbps (110.1%) |
| Baseline 3 | 255.5 Mbps (111.2%) |

TABLE 2
Average throughput achieved by the UEs with RARP => 095 dBm

| Methods | Average Throughput Achieved by UEs |
|---|---|
| This DOI | 291.1 Mbps (109.3%) |
| Baseline 1 | 266.3 Mbps (100%) |
| Baseline 2 | 281.2 Mbps (105.6%) |
| Baseline 3 | 285.9 Mbps (107.4%) |

The comparison with Baseline 3 further highlights that, using the provided methods in this DOI, the distributed MIMO systems can outperform the systems where the same number of antennas and transmit power are congregated at a single TRP. This demonstrates the advantages of the distributed MIMO systems, where additional degree-of-freedoms can be achieved by deploying multiple TRPs distributed in a geographic area.

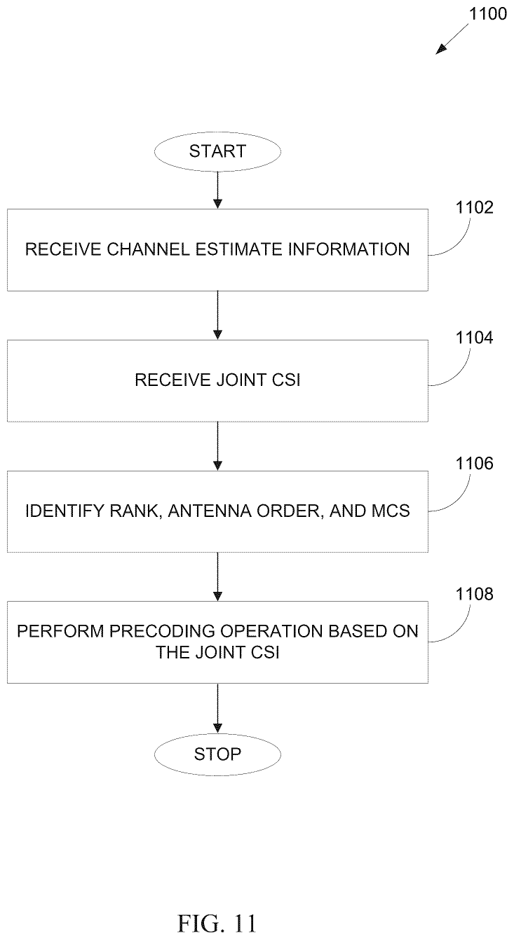

FIG. 11 illustrates a flowchart of a method 1100 for a joint transmission in a distributed MIMO with CSI sharing according to various embodiments of the present disclosure. The method 1100 may be performed by a network entity (e.g., base station, 101-103 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, in step 1102, a network entity receives, from mTRPs, channel estimate information associated with UEs communicated to the mTRPs.

Next, in step 1104, the network entity receives, from active mTRPs among the mTRPs, joint CSI of a UE, wherein the active mTRPs simultaneously communicate with the UE.

Subsequently, in step 1106, the network entity identifies, based on the channel estimate information, a rank, an antenna order, and an MCS for channels transmitted to the mTRPs.

Finally, in step 1108, the network entity performs a precoding operation to identify, based on the joint CSI, a precoder for the UE.

In one embodiment, a network entity adjusts a transmit power for each of the mTRPs, the transmit power being adjusted, on at least one layer of each of the mTRPs, to satisfy a maximum transmit power constraint or adjusts the transmit power for each antenna configured in each of the mTRPs, the transmit power being adjusted to satisfy a PAPC.

In one embodiment, a network entity performs, based on the channel estimate information, a normalization operation for the precoder and at least one layer for the UE.

In one embodiment, a network entity performs a join link adaptation based on first channel estimate information received from one of the active mTRPs. In such embodiments, the one of the active mTRPs comprises a serving TRP communicating with the UE, and the first channel estimate information is included in the channel estimate information received from the mTRPs.

In one embodiment, the channel estimate information is measured, at each of the mTRPs, based on SRSs received from UEs belonging to each of the mTRPs.

In one embodiment, the rank, the antenna order, and the MCS are selected based on a joint SRS channel matrix identified based on SRSs received from one of the active mTRPs, and the one of the active mTRP comprises a serving TRP communicating with the UE.

In one embodiment, a network entity identifies, based on an exhaustive searching operation, an RI of the rank and the antenna order, the exhaustive searching operation searching over entire combinations of the RI and the antenna order based on a maximum sum MPR.

In one embodiment, a network entity identifies a first antenna order while fixing a RI of the rank that is a maximum allowable rank, the first antenna order being a best antenna order among antenna orders associated with the UEs and identifies the RI of the rank that achieves a maximum objectiveness after identifying the first antenna order. In such embodiment, the maximum objectiveness is configured based on a network operator's desire or requirement profile.

In one embodiment, a network entity identifies, based on the rank and the antenna order, a joint precoder using a zero-forcing precoding operation including an inverse matrix of a channel matrix for the channels associated with the UEs and adjusts the joint precoder, when a transmit power of the mTRPs exceeds a maximum transmit power constraint, using at least one of: (i) a joint per-TRP per-layer power control operation that jointly controls the transmit power across the active mTRPs over each layer, (ii) a joint per-TRP power control operation that jointly controls the transmit power across the active mTRPs, or (iii) an individual per-TRP per-layer power control operation that individually controls each of mTRPs.

In one embodiment, a network entity adjusts the precoder for each of mTRPs using at least one of: (i) a joint PAPC operation that adjusts the precoder across entire antennas of the mTRPs, or (ii) an individual PAPC operation that adjusts the precoder across entire antennas at each of the mTRPs.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A network entity in a wireless communication network, the network entity comprising:
a transceiver configured to:
receive, from multiple transmit-receive-points (mTRPs), channel estimate information associated with user equipments (UEs) communicated to the mTRPs, and
receive, from active mTRPs among the mTRPs, joint CSI of a UE; and
a processor operably coupled to the transceiver, the processor configured to identify, based on the channel estimate information and the joint CSI, a rank, an antenna order, and a modulation and coding scheme (MCS) for channels transmitted to the mTRPS,
wherein the active mTRPS simultaneously communicate with the UE, and
wherein the processor is further configured to perform a precoding operation to identify, based on the joint CSI, a precoder for the UE.

2. The network entity of claim 1, wherein the processor is further configured to:
adjust a transmit power for each of the mTRPs, the transmit power being adjusted, on at least one layer of each of the mTRPs, to satisfy a maximum transmit power constraint; or
adjust the transmit power for each antenna configured in each of the mTRPs, the transmit power being adjusted to satisfy a per-antenna transmit power constraint (PAPC).

3. The network entity of claim 1, wherein the processor is further configured to perform, based on the channel estimate information, a normalization operation for the precoder and at least one layer for the UE.

4. The network entity of claim 1, wherein:
the processor is further configured to perform a join link adaptation based on first channel estimate information received from one of the active mTRPs; and
the one of the active mTRPs comprises a serving TRP communicating with the UE, and
the first channel estimate information is included in the channel estimate information received from the mTRPs.

5. The network entity of claim 1, wherein the channel estimate information is measured, at each of the mTRPs, based on surrounding reference signals (SRSs) received from UEs belonging to each of the mTRPs.

6. The network entity of claim 1, wherein:
the rank, the antenna order, and the MCS are selected based on a joint surrounding reference signal (SRS) channel matrix identified based on SRSs received from one of the active mTRPs, and
the one of the active mTRP comprises a serving TRP communicating with the UE.

7. The network entity of claim 1, wherein the processor is further configured to identify, based on an exhaustive searching operation, a rank indicator (RI) of the rank and the antenna order, the exhaustive searching operation searching over entire combinations of the RI and the antenna order based on a maximum sum modulation order product code rate (MPR).

8. The network entity of claim 1, wherein the processor is further configured to:
identify a first antenna order while fixing a rank indicator (RI) of the rank that is a maximum allowable rank, the first antenna order being a best antenna order among antenna orders associated with the UEs;
identify the RI of the rank that achieves a maximum objectiveness after identifying the first antenna order; and
the maximum objectiveness is configured based on a network operator's requirement profile.

9. The network entity of claim 1, wherein the processor is further configured to:
identify, based on the rank and the antenna order, a joint precoder using a zero-forcing precoding operation including an inverse matrix of a channel matrix for the channels associated with the UEs; and
adjust the joint precoder, when a transmit power of the mTRPs exceeds a maximum transmit power constraint, using at least one of:
a joint per-TRP per-layer power control operation that jointly controls the transmit power across the active mTRPs over each layer,
a joint per-TRP power control operation that jointly controls the transmit power across the active mTRPs, or
an individual per-TRP per-layer power control operation that individually controls each of mTRPs.

10. The network entity of claim 1, wherein the processor is further configured to adjust the precoder for each of mTRPs using at least one of:
a joint per-antenna transmit power constraint (PAPC) operation that adjusts the precoder across entire antennas of the mTRPs, or
an individual PAPC operation that adjusts the precoder across entire antennas at each of the mTRPs.

11. A method of a network entity in a wireless communication network, the method comprising:
receiving, from multiple transmit-receive-points (mTRPs), channel estimate information associated with user equipments (UEs) communicated to the mTRPs;
receiving, from active mTRPs among the MTRPs, joint CSI of a UE, wherein the active mTRPS simultaneously communicate with the UE;
identifying, based on the channel estimate information and the joint CSI, a rank, an antenna order, and a modulation and coding scheme (MCS) for channels transmitted to the mTRPS; and
performing a precoding operation to identify, based on the joint CSI, a precoder for the UE.

12. The method of claim 11, further comprising:
adjusting a transmit power for each of the mTRPs, the transmit power being adjusted, on at least one layer of each of the mTRPs, to satisfy a maximum transmit power constraint; or
adjusting the transmit power for each antenna configured in each of the mTRPs, the transmit power being adjusted to satisfy a per-antenna transmit power constraint (PAPC).

13. The method of claim 11, further comprising performing, based on the channel estimate information, a normalization operation for the precoder and at least one layer for the UE.

14. The method of claim 11, further comprising performing a join link adaptation based on first channel estimate information received from one of the active mTRPs,
wherein:
the one of the active mTRPs comprises a serving TRP communicating with the UE, and
the first channel estimate information is included in the channel estimate information received from the mTRPs.

15. The method of claim 11, wherein the channel estimate information is measured, at each of the mTRPs, based on surrounding reference signals (SRSs) received from UEs belonging to each of the mTRPs.

16. The method of claim 11, wherein:
the rank, the antenna order, and the MCS are selected based on a joint surrounding reference signal (SRS) channel matrix identified based on SRSs received from one of the active mTRPs, and
the one of the active mTRP comprises a serving TRP communicating with the UE.

17. The method of claim 11, further comprising identifying, based on an exhaustive searching operation, a rank indicator (RI) of the rank and the antenna order, the exhaustive searching operation searching over entire combinations of the RI and the antenna order based on a maximum sum modulation order product code rate (MPR).

18. The method of claim 11, further comprising:
identifying a first antenna order while fixing a rank indicator (RI) of the rank that is a maximum allowable rank, the first antenna order being a best antenna order among antenna orders associated with the UEs; and
identifying the RI of the rank that achieves a maximum objectiveness after identifying the first antenna order,
wherein the maximum objectiveness is configured based on a network operator's requirement profile.

19. The method of claim 11, further comprising:
identifying, based on the rank and the antenna order, a joint precoder using a zero-forcing precoding operation including an inverse matrix of a channel matrix for the channels associated with the UEs; and
adjusting the joint precoder, when a transmit power of the mTRPs exceeds a maximum transmit power constraint, using at least one of:
a joint per-TRP per-layer power control operation that jointly controls the transmit power across the active mTRPs over each layer,
a joint per-TRP power control operation that jointly controls the transmit power across the active mTRPs, or
an individual per-TRP per-layer power control operation that individually controls each of mTRPs.

20. The method of claim 11, further comprising adjusting the precoder for each of mTRPs using at least one of:
a joint per-antenna transmit power constraint (PAPC) operation that adjusts the precoder across entire antennas of the mTRPs, or
an individual PAPC operation that adjusts the precoder across entire antennas at each of the mTRPs.
